(19) United States
(12) Patent Application Publication
(10) Pub. No.: US 2016/0341359 A1
(43) Pub. Date: Nov. 24, 2016

(54) HIGH PRESSURE TANK, METHOD OF MANUFACTURING HIGH PRESSURE TANK AND METHOD OF DESIGNING LINER SHAPE

(71) Applicant: TOYOTA JIDOSHA KABUSHIKI KAISHA, Toyota-shi (JP)

(72) Inventor: Shiro NISHIBU, Toyota-shi (JP)

(73) Assignee: TOYOTA JIDOSHA KABUSHIKI KAISHA, Toyota-shi (JP)

(21) Appl. No.: 15/155,118

(22) Filed: May 16, 2016

(30) Foreign Application Priority Data
May 21, 2015 (JP) 2015-103573

(51) Int. Cl. F17C 1/06

(52) U.S. Cl. CPC F17C 1/06; F17C 2203/013; F17C 2203/0604; F17C 2201/0104; F17C 2203/0663; F17C 2209/2154; F17C 2209/232; F17C 2260/01

(57) ABSTRACT

An object is to improve the strength of a high pressure tank that is manufactured by the filament winding method. There is provided a high pressure tank comprising a liner that forms an inner shell of the high pressure tank and includes a cylindrical portion in a cylindrical shape and dome portions in a curved shape that are extended from respective ends of the cylindrical portion; and a reinforcing layer that is formed by winding a fiber on an outer surface of the liner. Each of the dome portions is configured to have a predetermined curved shape that is different from an isotonic curve and that forms an isotonic curve in a process of winding the fiber on the dome portion by helical winding.

### CROSS-REFERENCE TO RELATED APPLICATIONS

This application claims priority rights based on the Japanese patent application of Application No. 2015-103573 applied for on May 21, 2015, and all the disclosures thereof are incorporated herein by reference.

### BACKGROUND

The present invention relates to a high pressure tank.

The filament winding method is a conventionally known method of manufacturing a high pressure tank. The filament winding method manufactures the high pressure tank by winding a fiber which a thermosetting resin is impregnated with (hereinafter may be simply referred to as “fiber”) on a liner that forms a core of the high pressure tank and curing the fiber. A high pressure tank with a fiber-reinforced resin layer of high strength formed on the outer surface of a liner is manufactured by the filament winding method. WO 2011/154994 A1 describes a configuration of each hemispherical dome portion of a liner that is formed in an isotonic curve, in order to improve the strength of the high pressure tank manufactured as described above.

The techniques employed to wind the fiber in the filament winding method are roughly classified into two types: hoop winding and filament winding. The hoop winding winds the fiber approximately perpendicularly to a longitudinal direction of the liner. The helical winding winds the fiber at a predetermined angle relative to the longitudinal direction of the liner. In the process of helical winding of the fiber on the liner, the fiber is folded and is thereby concentrated in the vicinity of a mouthpiece provided in the dome portion. This accordingly increases the thickness of the wound fiber layers in the vicinity of the mouthpiece of the dome portion, compared with the thickness in the other portions.

The technique described in WO 2011/154994 A1 forms the outer surface of the dome portion of the liner in an isotonic curve. Accordingly, the technique described in WO 2011/154994 A1 has a problem that the shape of the outer surface formed by winding the fiber becomes more significantly deviated from the isotonic curve with an increase in number of winds of the fiber in the vicinity of the mouthpiece of the dome portion. The fiber has the lower tensile strength in the thickness direction than the tensile strength in the length direction. The strength of the fiber layer formed by winding the fiber thereby decreases with an increase in deviation from the isotonic curve. The technique described in WO 2011/154994 A1 accordingly has a problem that the strength of an actually manufactured high pressure tank is lower than the design-based calculated strength of a high pressure tank. JP 2012-149739A and JP 2011-047486A also have similar problems.

### SUMMARY

There is accordingly a need to improve the strength of a high pressure tank.

In order to solve at least part of the above problems, the invention may be implemented by any of the following aspects.

(1) According to one aspect of the invention, there is provided a high pressure tank. The high pressure tank comprises a liner that forms an inner shell of the high pressure tank and includes a cylindrical portion in a cylindrical shape and dome portions in a curved shape that are extended from respective ends of the cylindrical portion; and a reinforcing layer that is formed by winding a fiber on an outer surface of the liner. At least one of the dome portions is configured to have a predetermined curved shape that is different from an isotonic curve and that forms an isotonic curve in a process of winding the fiber on the dome portion by helical winding.

In the high pressure tank of this aspect, At least one of the dome portions of the liner is configured to have the predetermined curved shape that is different from an isotonic curve and that forms an isotonic curve in the process of winding the fiber on the dome portion by helical winding. This configuration reduces the total amount of deviations of the shapes of respective fiber layers included in the reinforcing layer from the isotonic curve, compared with a configuration of the dome portion that is formed in an isotonic curve. As a result, this configuration improves the strength of the high pressure tank.

(2) In the high pressure tank of the above aspect, the predetermined curved shape may be a shape that forms an isotonic curve at a location of approximate center in a thickness direction of the reinforcing layer on the dome portion.

In the high pressure tank of this aspect, the predetermined curved shape of the dome portion is the shape that forms the isotonic curve at the location of approximate center in the thickness direction of the reinforcing layer on the dome portion in the state that the reinforcing layer is formed. This configuration minimizes the total amount of deviations of the shapes of the respective fiber layers included in the reinforcing layer from the isotonic curve. As a result, this configuration significantly improves the strength of the high pressure tank.

(3) In the high pressure tank of the above aspect, the predetermined curved shape may be a shape that gradually increases a deviation from the isotonic curve with a shift of a location from vicinity of a boundary between the cylindrical portion and the dome portion of the liner to vicinity of a center axis of the cylindrical portion.

In the high pressure tank of this aspect, the predetermined curved shape of the dome portion is set to a shape that is determined based on account the nature of helical winding in the filament winding method.

(4) According to another aspect of the invention, there is provided a method of designing a shape of a liner that forms an inner shell of a high pressure tank. The method of designing the shape of the liner comprises determining a shape of a provisional liner having dome portions that are extended from respective ends of a cylindrical portion in a cylindrical shape and are respectively formed in an isotonic curve; determining configuration of a provisional reinforcing layer that is formed by winding a fiber on an outer surface of the provisional liner; setting an isotonic curve inside of the provisional reinforcing layer; and determining a predetermined curved shape of the dome portion of a final liner, based on the set isotonic curve and thickness of the provisional reinforcing layer.

The method of designing the shape of the liner of this aspect readily determines the shape of the liner in the high pressure tank of the above aspect.

(5) In the method of designing the shape of the liner of the above aspect, the setting the isotonic curve may comprise setting the isotonic curve at a location of approximate center in a thickness direction of the provisional reinforcing layer.

The method of designing the shape of the liner of this aspect readily determines the shape of the liner in the high pressure tank of the above aspect.

The invention may be implemented by various aspects other than those described above: for example, a high pressure tank, a method of manufacturing a high pressure tank, an apparatus for manufacturing a high pressure tank, a liner used for manufacture of a high pressure tank, a method of manufacturing a liner, an apparatus for manufacturing a liner, a method of designing a shape of a liner, a method of winding a fiber by filament winding method, a filament winding apparatus, control methods of these apparatuses, computer programs that implement these control methods, and non-transitory storage media that store such computer programs. A high pressure tank according to one aspect of the invention aims to make the shape of the outer surface formed by winding the fiber in the dome portion of the liner closer to an isotonic curve. Other needs include improving the performances (for example, strength and durability) of the high pressure tank, reducing the manufacturing cost of the high pressure tank, reducing the number of manufacturing processes of the higher pressure tank, simplifying the manufacturing method of the high pressure tank, commonizing the manufacturing method of the high pressure tank, saving the resource in manufacturing the high pressure tank, improving the performances of the liner, simplifying the method of designing the shape of the liner, reducing the manufacturing cost of the liner, reducing the number of manufacturing processes of the liner, simplifying the manufacturing method of the liner, commonizing the manufacturing method of the liner, and saving the resources in manufacturing the liner.

### BRIEF DESCRIPTION OF THE DRAWINGS

FIG. 1 is a diagram illustrating the configuration of a high pressure tank according to one embodiment of the invention;

FIG. 2A is diagram illustrating fiber winding techniques employed in filament winding method;

FIG. 2B is diagram illustrating fiber winding techniques employed in filament winding method;

FIG. 3 is a partial enlarged view illustrating the vicinity of a liner dome portion shown in FIG. 1;

FIG. 4A is diagram illustrating summation of deviations;

FIG. 4B is diagram illustrating summation of deviations;

FIG. 5 is a flowchart showing a procedure of designing the liner shape;

FIG. 6 is a diagram illustrating processes P10 to P30 in the method of designing the liner shape;

FIG. 7 is a diagram illustrating process P40 in the method of designing the liner shape;

FIG. 8 is a diagram illustrating process P50 in the method of designing the liner shape;

FIG. 9 is a diagram illustrating the result of performance evaluation with regard to a high pressure tank of the embodiment; and

FIG. 10 is a diagram illustrating the result of performance evaluation with regard to a high pressure tank of a comparative example.

### DESCRIPTION OF THE EMBODIMENTS

### A. Embodiment

### A-1. Configuration of High Pressure Tank

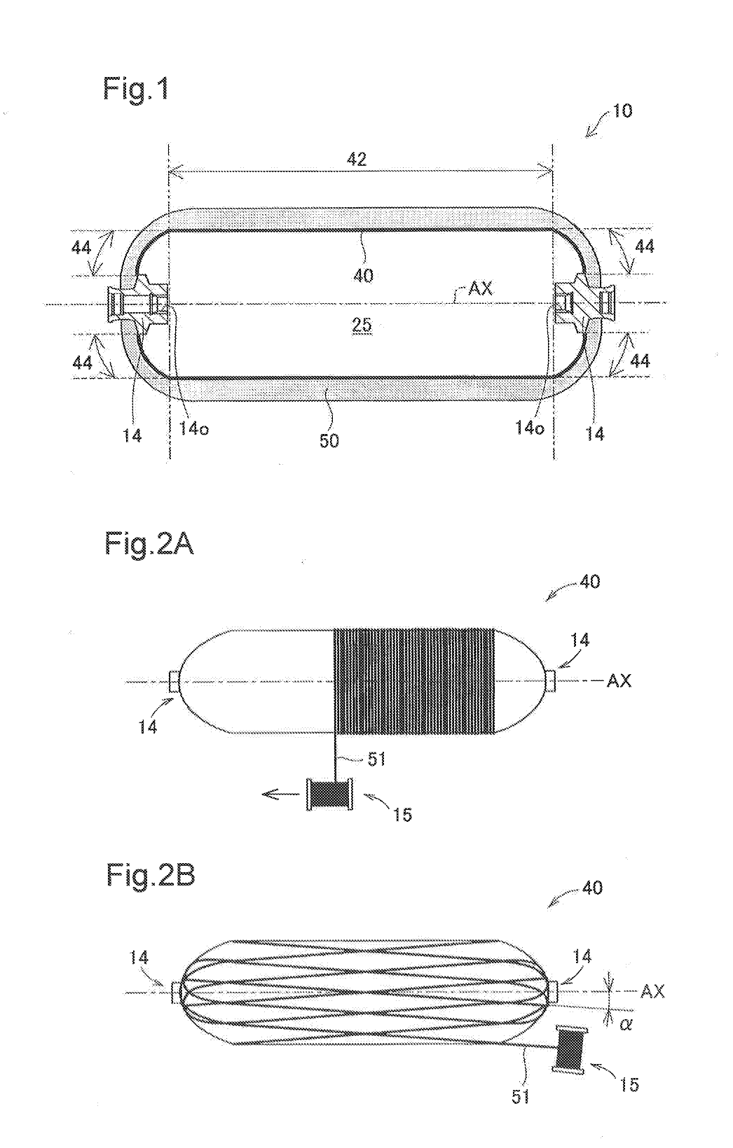

FIG. 1 is a diagram illustrating the configuration of a high pressure tank 10 according to one embodiment of the invention. FIG. 1 illustrates the sectional configuration of the high pressure tank 10. The high pressure tank 10 includes a liner 40, a reinforcing layer 50 provided to cover the outer surface of the liner 40 and two mouthpieces 14. Each of the mouthpieces 14 has an opening 14o. One of the two mouthpieces 14 may be omitted as appropriate.

The liner 40 is also called inner shell or inner vessel of the high pressure tank 10 and has a cavity 25 to store a fluid therein. The liner 40 has gas barrier property and suppresses a gas such as hydrogen gas stored in the cavity 25 from being transmitted to outside. The liner 40 is formed from a synthetic resin such as a nylon-based resin or a polyethylene-based resin or a metal such as stainless steel. According to this embodiment, the liner 40 is integrally molded from a nylon-based resin.

The liner 40 includes a liner cylindrical portion 42 and liner dome portions 44. The liner cylindrical portion 42 denotes a part of the liner 40 in a cylindrical shape and is an inner part marked by the two-dot chain line in FIG. 1. The liner cylindrical portion 42 serves as the “cylindrical portion”.

The liner dome portion 44 denotes a part in a hemispherical shape (i.e., dome shape or curved shape) extended from the liner cylindrical portion 42 and is an outer part marked by the two-dot chain line in FIG. 1. The liner dome portion 44 is tapered to have the diameter decreasing with an increase in distance away from the liner cylindrical portion 42 in a direction of center axis AX of the liner cylindrical portion 42 (shown by the one-dot chain line in FIG. 1). The most tapered part of the liner dome portion 44 forms an opening, and the mouthpiece 14 is inserted in the opening. The liner dome portion 44 serves as the “dome portion”.

The reinforcing layer 50 is a fiber layer formed by winding a fiber impregnated with a thermosetting resin on the outer surface of the liner 40. The thermosetting resin used may be, for example, an epoxy resin, a polyester resin or a polyamide resin. According to this embodiment, an epoxy resin is employed as the thermosetting resin. The fiber used may be, for example, an inorganic fiber such as metal fiber, glass fiber, carbon fiber or alumina fiber, a synthetic organic fiber such as aramid fiber or a natural organic fiber such as cotton. Any of these fibers may be used alone, or two or more different types of fibers may be used in combination. According to this embodiment, a carbon fiber is employed as the fiber. The term “fiber” in the description hereof is inclusive of both a single fiber and a fiber bundle consisting of a plurality of fibers.

FIGS. 2A and 2B are diagrams illustrating fiber winding techniques employed in the filament winding method. The reinforcing layer 50 shown in FIG. 1 is formed by the filament winding method. The filament winding method winds the fiber on the liner 40 by hoop winding and helical winding to form the reinforcing layer 50. Heating is subsequently applied to the liner 40 with the reinforcing layer 50 formed thereon, so as to cure the thermosetting resin which the fiber is impregnated with.

FIG. 2A is a diagram illustrating hoop winding. FIG. 2A illustrates the process of hoop winding of a fiber 51 on the liner 40. The hoop winding moves the winding position (i.e., the position of a guide 15) in the direction of center axis AX, while winding the fiber 51 such that the fiber 51 is arranged approximately perpendicular to the center axis AX of the liner cylindrical portion 41. In other words, the hoop winding is the technique of winding the fiber 51 such that the angle between the center axis AX and the winding direction of the fiber 51 is approximately right angle. The term “approximately perpendicular” or “approximately right angle” herein is inclusive of just 90 degrees and angles around 90 degrees that may be caused by shifting the winding position of the fiber 51 to prevent winds of the fiber 51 from overlapping with each other.

FIG. 2B is a diagram illustrating helical winding. FIG. 2B illustrates the process of helical winding of the fiber 51 on the liner 40. The helical winding moves the winding position around the liner 40, while winding the fiber 51 such that the fiber 51 forms a predetermined angle to the center axis AX of the liner cylindrical portion 42. In other words, the helical winding is the technique of winding the fiber 51 such that angle α between the center axis AX and the winding direction of the fiber 51 is a predetermined angle. The predetermined angle may be set arbitrarily. For example, setting a small angle to the predetermined angle provides a winding technique (low angle helical winding) that causes the winding direction of the fiber 51 to be turned in the liner dome portion 44 before the fiber 51 goes around the center axis AX, as shown in FIG. 2B. Setting a larger angle to the predetermined angle, on the other hand, provides a winding technique (high angle helical winding) that causes the fiber 51 to go around the center axis AX at least once in the liner cylindrical portion 42 before the winding direction of the fiber 51 is turned in the liner dome portion 44.

The hoop winding and the helical winding of the fiber 51 on the liner 40 forms multiple layers of the fiber 51 on the outer surface of the liner 40. In the description hereinafter, each layer of the fiber 51 is called “single fiber layer” or “fiber layer”. The reinforcing layer 50 is made of a plurality of single fiber layers.

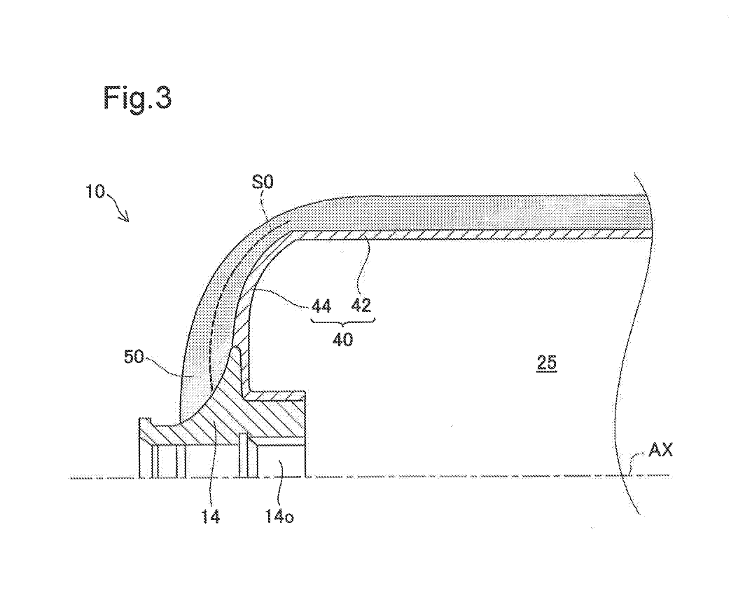

FIG. 3 is a partial enlarged view illustrating the vicinity of the liner dome portion 44 shown in FIG. 1. In the liner 40 according to this embodiment, the outer surface of the liner dome portion 44 is formed in a predetermined curved shape that is different from an isotonic curve. The “predetermined curved shape” of this embodiment denotes a shape that forms an isotonic curve S0 (shown by the broken line in FIG. 3) at a location of approximate center in the thickness direction of the reinforcing layer 50 in the state that the fiber 51 is helically wound to form the reinforcing layer 50 consisting of a plurality of single fiber layers. In other words, the predetermined curved shape denotes a shape that forms the isotonic curve S0 (shown by the broken line in FIG. 3) in the process of winding the fiber 51 on the liner dome portion 44 by helical winding. The isotonic curve S0 may consist of one single fiber layer or may consist of a plurality of single fiber layers. In the latter case, the plurality of single fiber layers may be arranged to be adjacent to one another or to be overlapped with one another.

According to this embodiment, the “thickness of the reinforcing layer 50” in a certain location means the thickness of the reinforcing layer 50 on a perpendicular that is drawn from the certain location on the outer surface of the liner dome portion 44 in the thickness direction of the liner dome portion 44. The thickness of the reinforcing layer 50 accordingly differs depending on the location on the outer surface of the liner dome portion 44. In the embodiment, the “approximate center” is preferably in the range of ±10% from the center in the thickness direction of the reinforcing layer 50 and is more preferably in the range of ±3%.

The fiber 51 has the lower tensile strength in the thickness direction than the tensile strength in the length direction. In order to ensure the sufficient strength of the fiber 51 in each single fiber layer and suppress deviation of the fiber 51 in each single fiber layer, it is preferable that an isotonic curve is formed in each single fiber layer. Due to the nature of helical winding, however, the fiber 51 is folded and is thereby concentrated in the vicinity of the mouthpiece 14 of the liner dome portion 44. As shown in FIG. 3, the vicinity of the mouthpiece 14 of the liner dome portion 44 accordingly has the larger number of single fiber layers to increase the thickness of the reinforcing layer 50, compared with the other locations (for example, boundary between the liner dome portion 44 and the liner cylindrical portion 42). Due to the nature of helical winding, it is thus difficult to form an isotonic curve in each single fiber layer over the entire area of the liner dome portion 44 from the vicinity of the mouthpiece 14 to the vicinity of the liner cylindrical portion 42.

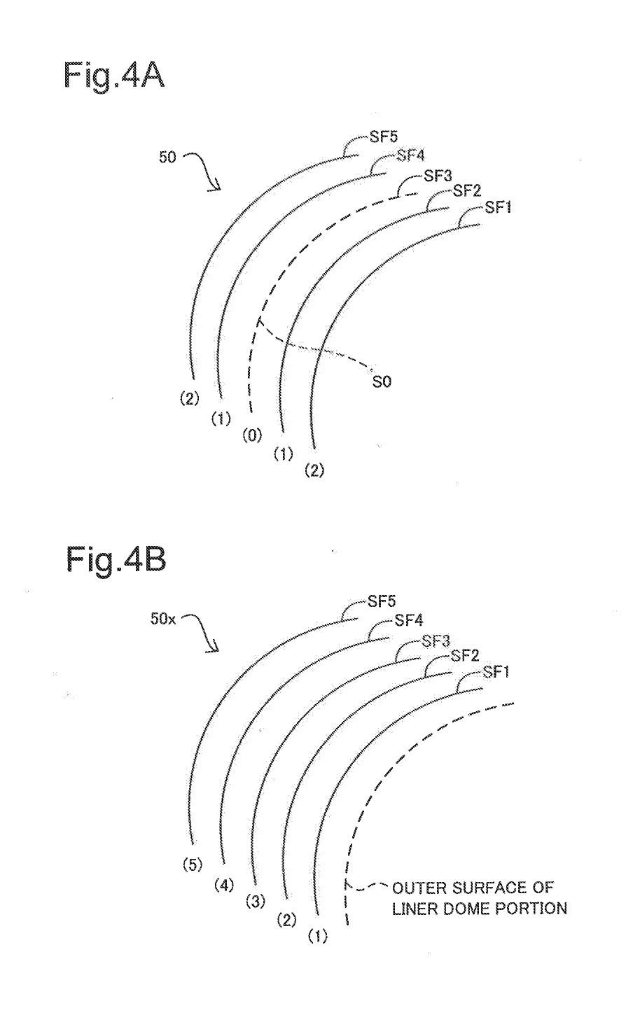

FIGS. 4A and 4B are diagrams illustrating summation of deviations. FIG. 4A illustrates five single fiber layers included in the reinforcing layer 50 with regard to the high pressure tank 10 of the embodiment. As described above with reference to FIG. 3, in the high pressure tank 10, an isotonic curve S0 is formed at the location of approximate center in the thickness direction of the reinforcing layer 50. That is to say, the reinforcing layer 50 includes an isotonic curve S0. For example, when a single fiber layer SF3 of FIG. 4A is a single fiber layer located at the approximate center in the thickness direction of the reinforcing layer 50, an isotonic curve S0 is formed in the single fiber layer SF3. It is assumed that the shape of a single fiber layer that is away from the isotonic curve by one layer has an amount of deviation “1” from the isotonic curve. As shown by numerals in brackets in FIG. 4A, the single fiber layer SF3 has an amount of deviation “0”; single fiber layers SF2 and SF4 have amounts of deviation “1”; and single fiber layers SF1 and SF5 have amounts of deviation “2”. As a result, in the embodiment shown in FIG. 4A, the total amount of deviations in the configuration of the reinforcing layer 50 by stacking the five single fiber layers is “2+1+0+1+2=6”.

FIG. 4B illustrates five single fiber layers included in a reinforcing layer 50x with regard to a high pressure tank of a comparative example. In the high pressure tank of the comparative example, an isotonic curve is formed on the outer surface of a liner dome portion. As shown by numerals in brackets in FIG. 4B, a single fiber layer SF1 has an amount of deviation “1”; a single fiber layer SF2 has an amount of deviation “2”; a single fiber layer SF3 has an amount of deviation “3”; a single fiber layer SF4 has an amount of deviation “4”; and a single fiber layer SF5 has an amount of deviation “5”. As a result, in the comparative example shown in FIG. 4B, the total amount of deviations in the configuration of the reinforcing layer 50x by stacking the five single fiber layers is “1+2+3+4+5=15”.

As described above, forming the isotonic curve S0 at the location of approximate center in the thickness direction of the reinforcing layer 50 (shown in FIGS. 3 and 4A) significantly reduces the total amount of deviations of the shape of the single fiber layers from the isotonic curve, compared with forming the isotonic curve on the outer surface of the liner dome portion 44 (shown in FIG. 4B). As a result, the high pressure tank 10 of the embodiment has the sufficient strength of the fiber 51 in each single fiber layer included in the reinforcing layer 50, compared with the high pressure tank of the comparative example. This significantly improves the strength of the high pressure tank 10.

### A-2. Method of Designing Liner Shape

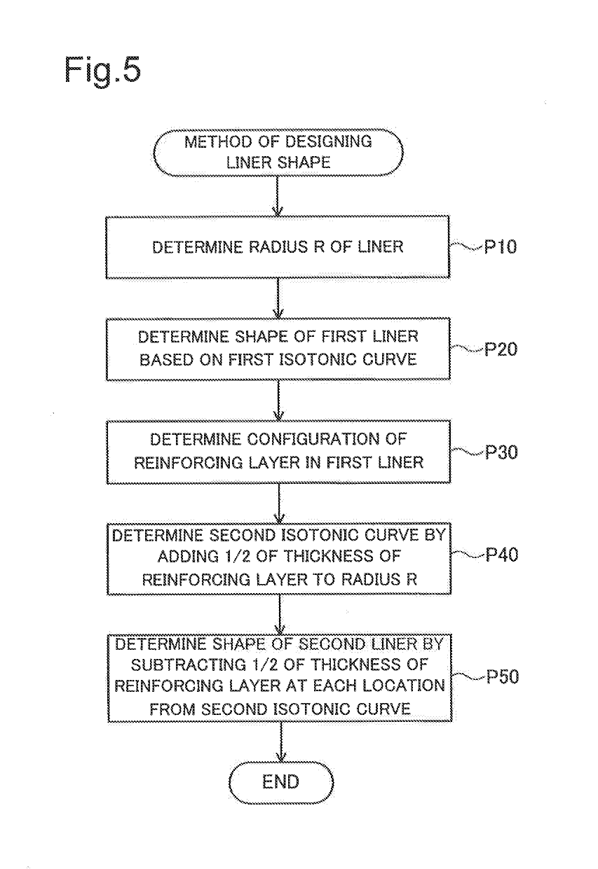

FIG. 5 is a flowchart showing a procedure of designing the liner shape. The shape of the liner 40 (shown in FIG. 3) used for the high pressure tank 10 of the embodiment is designed according to the procedure shown in FIG. 5.

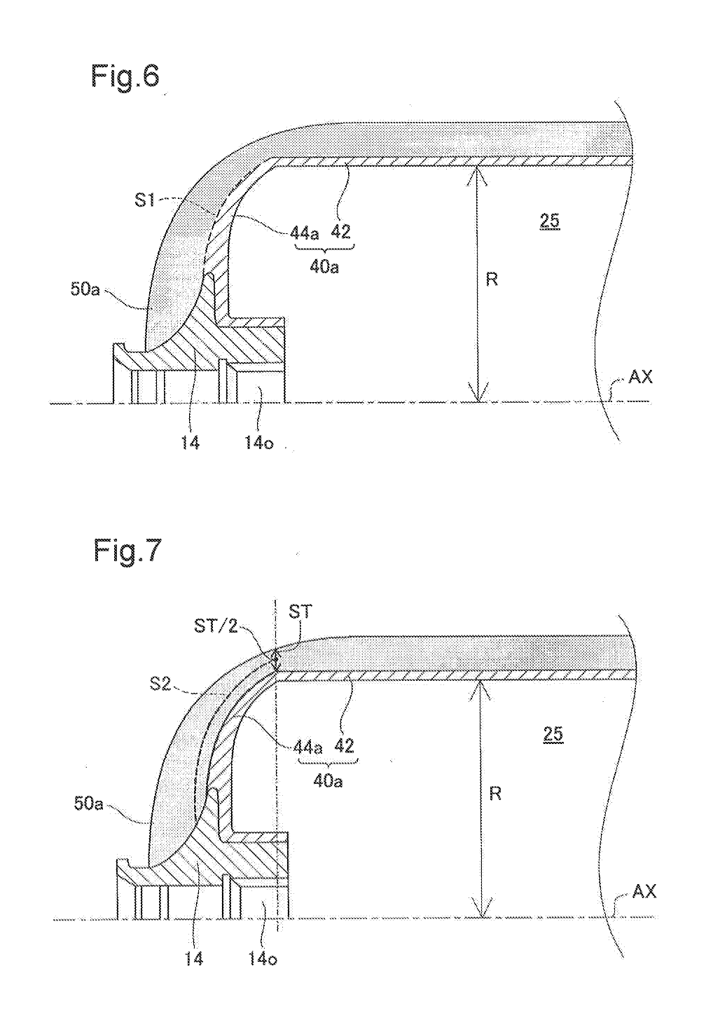

FIG. 6 is a diagram illustrating processes P10 to P30 in the method of designing the liner shape. In FIG. 6 and subsequent drawings, a provisional liner used to obtain the shape of the final liner 40 is shown with a suffix “a”. For example, a liner 40a corresponds to the liner 40 but is in a different shape. A liner dome portion 44a corresponds to the liner dome portion 44 but is in a different shape. In the description hereinafter, the provisional liner 40a is also called “first liner 40a”, and the final liner 40 is also called “second liner 40”.

Process P10 in FIG. 5 determines a radius R of the liner (shown in FIG. 6). The radius R is common between the first liner 40a and the second liner 40. The radius R may be determined, for example, according to the required capacity for the high pressure tank 10.

Process P20 in FIG. 5 determines the shape of the first liner 40a, based on a first isotonic curve. More specifically, as shown by the broken line in FIG. 6, the shape of the outer surface of the liner dome portion 44a of the first liner 40a is formed to an isotonic curve S1. The isotonic curve S1 is also called “first isotonic curve S1”.

Process P30 in FIG. 5 determines the configuration of a reinforcing layer 50a of the first liner 40a (shown in FIG. 6). More specifically, process P30 computes the amount of the fiber 51 to be wound according to the required strength for the high pressure tank 10. Process P30 subsequently determines the configuration of the reinforcing layer 50a formed by hoop winding and helical winding of the computed amount of the fiber 51 on the first liner 40a. The reinforcing layer 50a serves as “provisional reinforcing layer”.

FIG. 7 is a diagram illustrating process P40 in the method of designing the liner shape. Process P40 in FIG. 5 determines a second isotonic curve by adding ½ of the thickness of the reinforcing layer 50a to the radius R. More specifically, as shown in FIG. 7, process P40 specifies a reference point by adding ½ of a thickness ST of the reinforcing layer 50a (i.e., ST/2) to the radius R with regard to the boundary between the liner dome portion 44a of the first liner 40a and the liner cylindrical portion 42. Process P40 subsequently determines an isotonic curve S2 (shown by the broken line in FIG. 7) starting from the specified reference point. The isotonic curve S2 is also called “second isotonic curve S2”.

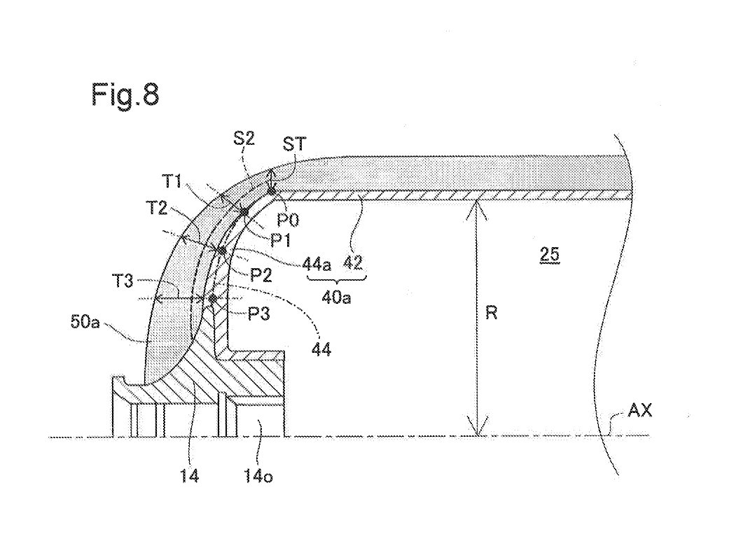

FIG. 8 is a diagram illustrating process P50 in the method of designing the liner shape. Process P50 in FIG. 5 determines the shape of the second liner 40 by subtracting ½ of the thickness of the reinforcing layer 50a at each location from the second isotonic curve S2. More specifically, process P50 includes the following steps a1 and a2:

(a1) with regard to each location of the first liner 40a from the boundary between the liner dome portion 44a and the liner cylindrical portion 42 to the vicinity of the mouthpiece 14, specifying a point by subtracting ½ of the thickness of the reinforcing layer 50a formed on the outer surface at each location from the second isotonic curve S2 determined at process P40; and
(a2) determining the shape of the outer surface of the second liner 40 (more specifically, the shape of the outer surface of the liner dome portion 44) such as to go through the respective points specified by the step a1.

The shape of the outer surface of the liner dome portion 44 determined at step a2 serves as the “predetermined curved shape”.

FIG. 8 illustrates an example in which the above steps a1 and a2 are performed with regard to three locations in the first liner 40a. More specifically, a point P1 is computed by subtracting ½ of a thickness T1 of the reinforcing layer 50a from the second isotonic curve S2. Similarly, a point P2 is computed by subtracting ½ of a thickness T2 of the reinforcing layer 50a from the second isotonic curve S2. A point P3 is computed by subtracting ½ of a thickness T3 of the reinforcing layer 50a from the second isotonic curve S2. As a result, in the example of FIG. 8, the predetermined curved shape of the liner dome portion 44 of the second liner 40 (shown by the one-dot chain line in FIG. 8) is determined to a shape that goes through the computed points P1 to P3.

As clearly understood from the example of FIG. 8, the thickness of the reinforcing layer 50a increases with a shift of the location as the object of processing of the steps a1 and a2 from the vicinity of the boundary between the liner dome portion 44a and the liner cylindrical portion 42 to the vicinity of the mouthpiece 14. Accordingly, the values to be subtracted for computation of the points P1 to P3 satisfy the relationship of (T1/2)<(T2/2)<(T3/2).

As a result, with regard to the finally obtained second liner 40, the predetermined curved shape of the liner dome portion 44 is not an isotonic curve but is a shape that is more recessed in the vicinity of the mouthpiece 14 compared with the first liner 40a. In other words, the predetermined curved shape of the liner dome portion 44 is a shape that gradually increases the deviation from the isotonic curve S0 (shown by the broken line in FIG. 3) or from the second isotonic curve S2 (shown by the broken line in FIG. 7) with a shift of the location from the vicinity of the boundary between the liner cylindrical portion 42 and the liner dome portion 44 to the vicinity of the center axis AX of the liner cylindrical portion 42 (i.e., the vicinity of the mouthpiece 14).

For convenience of illustration, FIG. 8 shows the example in which the above steps a1 and a2 are performed with regard to three locations of the first liner 40a. In the method of designing the liner shape (shown in FIG. 5), however, the number of locations for which the steps a1 and a2 are performed may be determined arbitrarily. The greater number of locations is preferable, in terms of improving the accuracy.

As described above, the method of designing the liner shape according to the above embodiment readily determines the shape of the liner 40 in the high pressure tank 10 of the embodiment (shown in FIG. 3).

### A-3. Evaluation

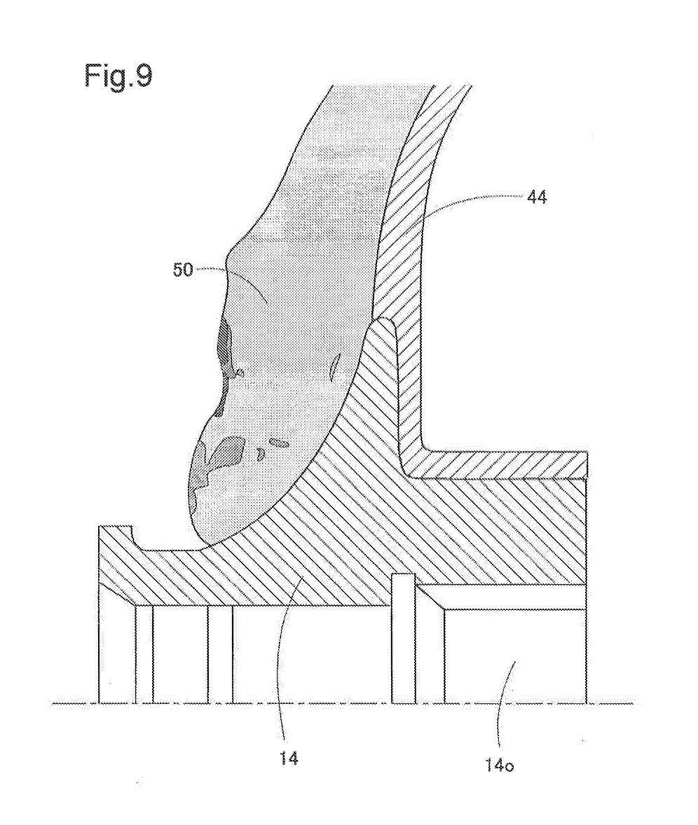

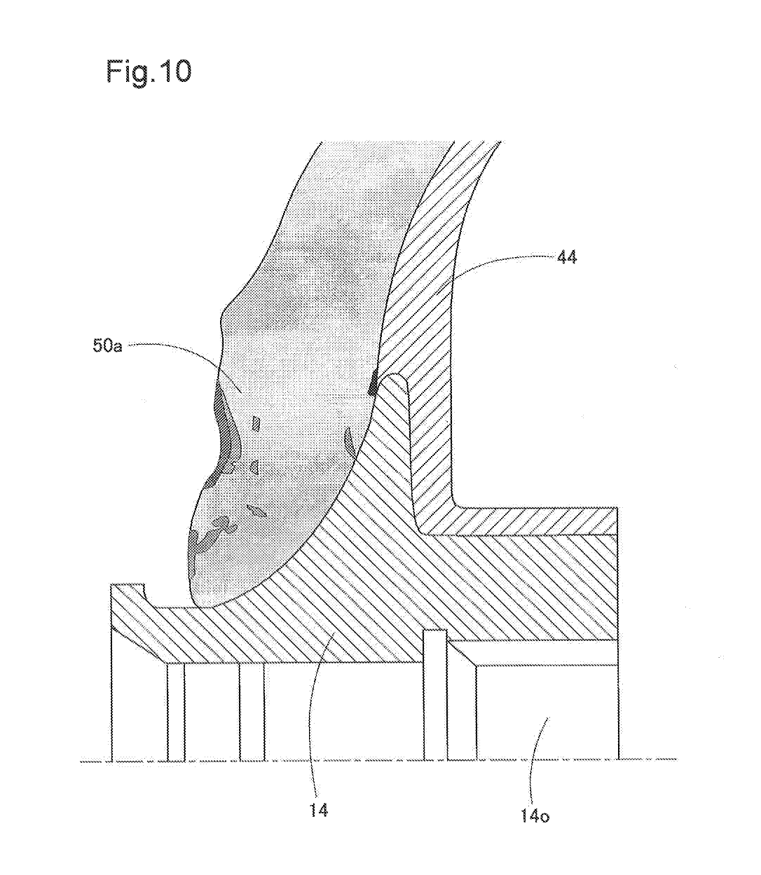

FIG. 9 is a diagram illustrating the result of performance evaluation with regard to the high pressure tank 10 of the embodiment. FIG. 10 is a diagram illustrating the result of performance evaluation with regard to a high pressure tank of a comparative example. The performance evaluation employs the finite element method (FEM) of CAE (computer-aided engineering) analysis to compute the strain of the fiber 51 in reinforcing layers 50 and 50a with regard to the following two high pressure tanks:

high pressure tank 10 of the embodiment: high pressure tank that includes a second liner 40 obtained by the method of designing the liner shape (shown in FIG. 5): and

high pressure tank of comparative example: high pressure tank that includes a first liner 40a in the method of designing the liner shape (shown in FIG. 5).

In FIGS. 9 and 10, light-colored hatching indicates an area having small strain of the fiber 51, and the color of hatching is changed to the darker color with an increase in strain of the fiber 51. As illustrated, compared with the high pressure tank of the comparative example (shown in FIG. 10), the high pressure tank 10 of the embodiment (shown in FIG. 9) has reduction of a large strain at an end of the mouthpiece 14. The high pressure tank 10 of the embodiment also has reduction of strain over a wide area on the outer surface of the reinforcing layer 50. The high pressure tank 10 of the embodiment has reduction of the maximum strain computed by CAE analysis by approximately 5%, compared with the high pressure tank of the comparative example.

As described above, in the high pressure tank 10 of the above embodiment, the shape of the outer surface of the liner dome portion 44 (dome portion) of the liner 40 (shown in FIG. 3) is the predetermined curved shape that is different from an isotonic curve and that forms the isotonic curve S0 (shown by the broken line in FIG. 3) in the process of winding the fiber 51 on the liner dome portion 44 by helical winding. As described above with reference to FIG. 4, this configuration reduces the total amount of deviations of the shapes of the respective single fiber layers (respective fiber layers) included in the reinforcing layer 50 from the isotonic curve, compared with the configuration of the liner dome portion 44 that is formed in an isotonic curve. As a result, this configuration ensures the sufficient strength of the fiber 51 in each single fiber layer included in the reinforcing layer 50 in the high pressure tank 10 of the embodiment and thereby improves the strength of the high pressure tank 10.

In the high pressure tank 10 of the above embodiment, the predetermined curved shape is the shape that forms the isotonic curve S0 (shown by the broken line in FIG. 3) at the location of approximate center in the thickness direction of the reinforcing layer 50 in the state that the fiber 51 is wound to form the reinforcing layer 50 consisting of a plurality of single fiber layers (fiber layers). This configuration minimizes the total amount of deviations of the respective single fiber layers (respective fiber layers) included in the reinforcing layer 50 from the isotopic curve as described above with reference to FIG. 4. As a result, this ensures the sufficient strength of the fiber 51 in each single fiber layer included in the reinforcing layer 50 in the high pressure tank 10 of the embodiment and thereby significantly improves the strength of the high pressure tank 10.

Additionally, in the high pressure tank 10 of the above embodiment, the predetermined curved shape is the shape that gradually increases the deviation from the isotonic shape with a shift of the location from the vicinity of the boundary between the liner cylindrical portion 42 (cylindrical portion) and the liner dome portion 44 (dome portion) of the liner 40 to the vicinity of the center axis AX of the liner cylindrical portion 42 (i.e., the vicinity of the mouthpiece 14) (as shown in FIG. 8). According to this embodiment, the predetermined curved shape of the liner dome portion 44 of the liner 40 may thus be set to a shape that takes into account the nature of helical winding in the filament winding method.

### B. Modifications

The invention is not limited to any of the aspects and the embodiment described above but may be implemented by a diversity of other aspects and configurations without departing from the scope of the invention. Some examples of possible modifications are given below.

### Modification 1

The above embodiment shows one example of the configuration of the high pressure tank. The configuration of the high pressure tank may, however, be changed, modified or altered in any of various ways, for example, by adding some components, deleting some components or changing some components.

For example, the reinforcing layer in the high pressure tank may be formed from a fiber wound by any suitable technique other than the hoop winding and the helical winding (including high angle helical winding and low angle helical winding) described above.

For example, the reinforcing layer in the high pressure tank may be formed from a plurality of different types of reinforcing layers having different functions (for example, CFRP layer and GFRP layer). In this modification, processes P40 and P50 in the method of designing the liner shape may perform the calculation based on the total thickness of the plurality of different types of reinforcing layers or may perform the calculation based on the thickness of one specified reinforcing layer (for example, CFRP layer).

### Modification 2

The above embodiment shows one example of the method of designing the liner shape. The method of designing the liner shape may, however, be changed, modified or altered in any of various ways, for example, by adding some processes, deleting some processes or changing the details of any process.

For example, process P20 sets the shape of the outer surface of the liner dome portion of the first liner to the first isotonic curve S1. The shape of the outer shape of the liner dome portion of the first liner may, however, be set to a different shape from the isotonic curve.

For example, process P40 specifies the reference point for determining the second isotonic curve S2 by adding ½ of the thickness of the provisional reinforcing layer to the radius R of the liner. The reference point may, however, be specified arbitrarily as long as the reference point is set inside of the provisional reinforcing layer. For example, the reference point may be specified by adding 1/n (where n denote an arbitrary positive number) of the thickness of the provisional reinforcing layer to the radius R. This modification also reduces the total amount of deviations of the shapes of the respective single fiber layers included in the reinforcing layer from the isotonic curve, compared with the configuration of the liner dome portion that is formed in an isotonic curve.

For example, process P50 determines the predetermined curved shape of the liner dome portion by subtracting ½ of the thickness of the provisional reinforcing layer at each location from the second isotonic curve S2. The value of the thickness to be subtracted from the second isotonic curve S2 may, however, be determined arbitrarily. For example, the value of the thickness to be subtracted from the second isotonic curve S2 may be 1/m (where m denotes an arbitrary positive number) of the thickness of the provisional reinforcing layer at each location. It is preferable that the number “m” of this modification is identical with the number “n” of the above modification. This modification also readily determines the shape of the liner used for the high pressure tank of the above embodiment.

### Modification 3

The invention is not limited to any of the embodiment, the examples and the modifications described above but may be implemented by a diversity of other configurations without departing from the scope of the invention. For example, the technical features of any of the embodiment, examples and modifications corresponding to the technical features of each of the aspects described in SUMMARY may be replaced or combined appropriately, in order to solve part or all of the problems described above or in order to achieve part or all of the advantageous effects described above. Any of the technical features may be omitted appropriately unless the technical feature is described as essential herein.

What is claimed is:

1. A high pressure tank, comprising:
a liner that forms an inner shell of the high pressure tank and includes a cylindrical portion in a cylindrical shape and dome portions in a curved shape that are extended from respective ends of the cylindrical portion; and
a reinforcing layer that is formed by winding a fiber on an outer surface of the liner, wherein
at least one of the dome portions is configured to have a predetermined curved shape that is different from an isotonic curve and that forms an isotonic curve in a process of winding the fiber on the dome portion by helical winding.

2. The high pressure tank according to claim 1,
wherein the predetermined curved shape is a shape that forms an isotonic curve at a location of approximate center in a thickness direction of the reinforcing layer on the dome portion.

3. The high pressure tank according to claim 1,
wherein the predetermined curved shape is a shape that gradually increases a deviation from the isotonic curve with a shift of a location from vicinity of a boundary between the cylindrical portion and the dome portion of the liner to vicinity of a center axis of the cylindrical portion.

4. A method of manufacturing a high pressure tank, comprising:
providing a liner that forms an inner shell of the high pressure tank and includes a cylindrical portion in a cylindrical shape and dome portions that are extended from respective ends of the cylindrical portion, at least one of the dome portions being configured to have a predetermined curved shape that is different from an isotonic curve; and
winding a fiber on an outer surface of the liner by helical winding to form a reinforcing layer, such that an isotonic curve is formed in the at least one of the dome portions.

5. A method of designing a shape of a liner that forms an inner shell of a high pressure tank, the method of designing the shape of the liner comprising:
determining a shape of a provisional liner having dome portions that are extended from respective ends of a cylindrical portion in a cylindrical shape and are respectively formed in an isotonic curve;
determining configuration of a provisional reinforcing layer that is formed by winding a fiber on an outer surface of the provisional liner;
setting an isotonic curve inside of the provisional reinforcing layer; and
determining a predetermined curved shape of the dome portion of a final liner, based on the set isotonic curve and thickness of the provisional reinforcing layer.

6. The method of designing the shape of the liner according to claim 5,
wherein the setting the isotonic curve comprises setting the isotonic curve at a location of approximate center in a thickness direction of the provisional reinforcing layer.
